(19) United States
(12) Patent Application Publication
(10) Pub. No.: US 2019/0303815 A1
(43) Pub. Date: Oct. 3, 2019

(54) DISTRIBUTED MANUFACTURING SYSTEM

(71) Applicant: SAP SE, Walldorf (DE)

(72) Inventors: Wen-Syan Li, Shanghai (CN); Jing Gu, Shanghai (CN); Mingjie Dong, Shanghai (CN); Shijie Huang, Shanghai (CN)

(21) Appl. No.: 15/940,720

(22) Filed: Mar. 29, 2018

(51) Int. Cl. G06Q 10/06; G06Q 10/08; G06Q 50/04

(52) U.S. Cl. CPC G06Q 10/0631; G06Q 50/04; G06Q 10/08355

(57) ABSTRACT

Various embodiments of systems and methods for distributed manufacturing are described herein. The method includes identifying a time window for executing an order for a product comprising various components. A task allocator is executed to read data related to the product to generate manufacturing topology of the product representing components with nodes and their manufacturing inter-dependency with edges. Based upon the manufacturing topology, supplier's timeline topology of the product is generated to indicate time taken to manufacture the product by respective suppliers. The generated suppliers' timeline topologies are merged with time inter-dependency relationship between each node to generate production timeline topology of the product. Routes from nodes without predecessor nodes to nodes without successor nodes in the production timeline topology is generated. An optimal route having minimum manufacturing cost of the product is selected. Based upon the selected route, the manufacturing tasks are assigned to the suppliers.

### BACKGROUND

Manufacturing industries play a vital role in the economy of a country. Manufacturing of commodities or products may be complex, e.g., when a product includes various components or parts which require different manufacturing materials, machines, and environment/conditions. Therefore, such products may be difficult to be manufactured at one place/factory/location (e.g., as centralized manufacturing) due to unavailability of different manufacturing materials, machines, and/or environment/conditions. Now-a-days, decentralized manufacturing may be used for manufacturing such products. Decentralized or distributed manufacturing refers to geographically dispersed manufacturing facilities to produce different components of the products and assembling them to produce a final product. In decentralized manufacturing, a manufactuer of final product may bring different components from different suppliers or vendors, different locations, and/or factories and assemble the components together to produce the final product.

Decentralized manufacturing, therefore, makes the production or manufacturing process easy and convenient as the final product can be easily and comfortably made, e.g., by gathering different components and assembling them. Further, decentralized manufacturing reduces effort, time, and cost involved in manufacturing each component of the product. However, due to voluminous demand of products and complex nature of distributed manufacturing (e.g., various manufacturing units or vendors), it might be an arduous and time consuming task to manage production process (e.g., selecting best suppliers for manufacturing various preparing production schedule or task assignments, etc.), task assignments to different suppliers, and maintaining transportation between different geographies or factories in a way to enable cost efficient manufacturing. Further, human based planning may be error prone, inefficient, and/or improper. The improper planning or scheduling may result in delay and high manufacturing and product cost which leads to customers' dissatisfaction and may, therefore, be detrimental to the manufacturers.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram illustrating components for optimizing task allocation in distributed manufacturing environment, according to an embodiment.

FIG. 2 is a block diagram illustrating inputs provided to a task allocator for updating optimized schedule, according to an embodiment.

FIG. 3 illustrates an exemplarily manufacturing topology of a product comprising three components, according to an embodiment.

FIG. 4 illustrates a generic supplier's timeline topology, according to an embodiment.

FIG. 5A illustrates supplier's timeline topology for the product generated using the generic supplier's timeline topology of FIG. 4, according to an embodiment.

FIG. 5B illustrates production timeline topology of the product generated based upon the supplier's timeline topology of the product of FIG. 5A, according to an embodiment.

FIG. 6 illustrates nodal pathways or routes from nodes without predecessor nodes to nodes without successor nodes in the production timeline topology of FIG. 5B, according to an embodiment.

FIG. 7 is a flowchart illustrating a process for optimizing task allocation in distributed manufacturing environment, according to an embodiment.

FIG. 8 is a block diagram illustrating an exemplary computer system, according to an embodiment.

### DESCRIPTION

Embodiments of techniques for distributed manufacturing system are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Embodiments provide optimized and efficient scheduling and assignments of resources and tasks in distributed manufacturing environment to enhance production and profit (e.g., by reducing production cost and/or time). The optimized scheduling enables to utilize right suppliers, at a right time, and right locations to shorten production cycle, reduce production time, reduce idle time, and reduce manufacturing cost to fulfil customers' orders (demand) along with maximizing profit. The assignments are done dynamically and quickly based upon changing circumstances, e.g., currently available suppliers, suppliers' production capacity, etc. Therefore, in case of unforeseen or changing circumstances (e.g., supplier unable to supply components due to some emergency or other issues), the assignments may be modified or updated dynamically and quickly so that the delivery of final product may not be delayed. Embodiments aim at enhancing profit by balancing the demand and supply, minimizing the cost incurred (e.g., the production cost, transportation cost, etc.) in manufacturing and delivering the order, shortening production cycle, and reducing idle time. Components delivery status may be tracked or monitored in real-time and then determination may be made for updating assignments based upon any changing or unforeseen circumstances.

Proper assignments or scheduling enable to fulfill order on time which brings customers' satisfaction along with enhancing or maximizing the revenue generated from the orders. The use of the in-memory database (SAP® HANA) allows to handle and pre-process very large assignment dataset, which boosts the system to provide a faster and real-time service. Replacement or alternative vendors or suppliers may be automatically determined or assigned and users are not required to manually figure out the replacement, assignment, and/or scheduling. Therefore, the supplier may be adjusted quickly and dynamically based upon the changing circumstances. Further, the user (e.g., the manufacturer) is given flexibility to interact with the workflow and input some customization such as a weight for manufacturing cost and manufacturing time according to their requirement. For example, if a user wants a product to be delivered fast, the user may reduce the weight of the manufacturing time. Based upon the user's requirement/input, the assignment or scheduling is generated or updated accordingly.

“Distributed manufacturing” or “decentralized manufacturing” refers to geographically dispersed manufacturing facilities to produce different components or parts of a product which may be assembled together to produce a final product. A product may comprise several components or parts and a part may be made up of different types of materials, an order for such product may be divided among several vendors or suppliers (e.g., different suppliers or vendors produce different components of the product/order). In various aspects, the parts or components may refer to the parts, components, or modules of a process.

“Manufacturer” refers to a person, a company, or an organization that makes final or end products and/or services for sale. For example, the manufacturer brings the components from different suppliers and assembles them to make the final product.

“Supplier” or “vendor” refers to a person, a company, or an organization that makes one or more components or parts of a final or end product.

“Topology” refers to a pattern of connection or a way in which parts or components of a product or process are arranged, connected, or inter-related. The topology may be with reference to manufacturing of the product and may be referred as ‘manufacturing topology’. For example, if a product ‘A’ comprises ‘part 1,’ ‘part 2,’ and ‘part 3’ such that the manufacturing of ‘part 1’ and ‘part 2’ are independent and the manufacturing of ‘part 3’ is dependent upon the manufacturing of ‘part 1’ and ‘part 2’ then the topology of product A may comprise of three blocks representing ‘part 1,’ ‘part 2,’ and ‘part 3,’ respectively, where block 3 is connected to both block 1 and block 2. A bill of materials or BOM (e.g., including information about a product such as its components, a list of materials for manufacturing the components, quantities of materials required for manufacturing components, etc.) may be used to generate a manufacturing topology of the end product. The topology may be in reference to any other parameter such as manufacturing time and may be referred as ‘timeline topology.’ The timeline topology may be (i) supplier's timeline topology indicating the time taken by a supplier to manufacture a component/product; and (ii) production timeline topology of a product indicating the time taken to manufacture a product through one or more suppliers (indicating their manufacturing time dependency on other components and/or on other suppliers (if any)).

“Supplier timeline topology” refers to a timeline topology illustrating time taken by a supplier to manufacture one or more components/product. For example, if a supplier is to manufacture a single component, then the supplier timeline topology may illustrate a single block or node representing the component to be manufactured and indicating time required to manufacture that component. In an embodiment, the ‘production timeline topology’ may be generated by replacing nodes of the ‘manufacturing topology’ with their respective supplier's timeline topology.

“Linear programming (LP)” refers to a technique or mathematical model for maximizing or minimizing a linear function of plurality of variables. Linear programming can alternately be defined as a technique for the optimization of a linear function, subject to linear equality and/or linear inequality constraints. Therefore, linear programming may also be termed as “linear optimization (LO)”. The linear programming provides a method to achieve the best output, e.g., maximum profit, minimum cost incurred, etc. The function which is optimized may be a real-valued linear function defined on a polyhedron (e.g., intersection of finitely many spaces, each of space is defined by a linear inequality) and a linear programming finds a point in the polyhedron where this function has the smallest (or largest) value if such a point exists.

“Transportation cost” refers to an expense involved in bringing the one or more components from the one or more suppliers or vendors locations to a final manufacturing point and/or expense involved in delivering the final order. The transportation cost may involve or include fuel cost, toll gate payment, etc.

“Production cost” refers to cost incurred in manufacturing or making a product. Production cost may include cost of materials, labor, manufacturing equipment, etc., involved in production of components of the product. The production cost of the components may be quoted by the suppliers.

“Product cost” refers to total cost incurred in manufacturing a final or end product. The product cost may be a combination of transportation cost, production cost, and cost involved in integrating and assembling the components (received from the suppliers) to make the final or end product. The product cost may include the cost of machine, labor, etc., involved in integrating or assembling to make the final product. The product cost may also be referred as “capital cost of a product” or “manufacturing cost of the product.”

“Capital cost of a component or a part” refers to total cost incurred in manufacturing that component or part. In various embodiments, the capital cost of the component may be referred as a manufacturing cost of the component.

“Manufacturing time of a product” refers to total time consumed in manufacturing a final or an end product. The manufacturing time of a product may include transportation time of the components (e.g., time spent in bringing the components from the suppliers) and the time consumed or spent in integrating and assembling the components (received from the suppliers) to make the final or end product. The manufacturing time may be predefined or prefixed (e.g., by the manufacturer) based upon the customer's or market requirement(s). For example, if the product has to be delivered fast or early, the manufacturing time may be reduced.

“Manufacturing time of a component or a part” refers to total time consumed in manufacturing that component or part. The manufacturing time of a component may be predefined or prefixed (e.g., by the supplier or vendor) based upon the manufacturer's requirement(s).

“Tolerable delay” refers to an admissible, manageable, or bearable delay in delivery of an order. Orders are generally required to be delivered on time, however, if the supplier could not provide the components on time, there may be delay in producing the final product or delivering the order. A period of delay should be tolerable. Delay causes reduce or loss in revenue generated from the orders. The tolerable delay may be predefined, e.g., by a user such as a customer or a manufacturer. In an embodiment, based upon the maximum loss that can be suffered, the tolerable delay may be predefined. For example, the maximum tolerable delay may be defined as three days or three hours.

“Task allocator module” refers to a logical and/or a physical unit which generates optimized or optimal tasks schedule to effectively, dynamically, and efficiently allocate or assign various manufacturing tasks to various vendors or suppliers to maximize profit. The task allocator module may also be termed as “task allocator” or “optimal assignment planner”. The tasks allocator reads various data related to an order such as quantity of ordered product, product components, materials required for manufacturing each component of the product, tolerable delay, information of various suppliers, stock of available materials with various suppliers, capital cost of components quoted by the suppliers, manufacturing time of components quoted by suppliers. etc. The data may be read from an information repository or database. In an embodiment, the data related to the product may be read from bill-of-material (BOM) including information about the product, its components, materials required to manufacture each component. In an embodiment, the data related to suppliers may be read from supplier database or repository. Based upon the read data and/or one or more constraints (e.g., tolerable delay, urgent order, suppliers non-working days, etc.) provided by one or more suppliers and/or manufacturer, the tasks allocator dynamically generates the most reasonable (optimal) task allocation schedule for different suppliers to maximize profit. The tasks allocator utilizes product topology and linear programming to generate the most reasonable task allocation schedule/planning. For example, if there are two suppliers to manufacture a component of an ordered product and the manufacturing cost quotation by 1^{st} supplier is more than the 2^{nd} supplier, however the transportation cost for the 1^{st} supplier is drastically less than the 2^{nd} supplier then the tasks allocator determines the best supplier among the two for manufacturing the component considering which may lead to maximum profit or less total product cost. If there are any changes during runtime such as the selected supplier cannot deliver on quoted time or cost, change in ordered product quantity, etc., these runtime changes or constraints may be provided to the task allocator to dynamically update optimized task allocation schedule and reallocate and re-assign the manufacturing tasks to various vendors according to the updated optimized schedule. Therefore, the tasks allocator provides most optimal tasks assignments with balancing product cost and manufacturing time to maximize profit.

“In-memory” database refers to a database that relies on main memory for computer data storage. In some examples, the in-memory database includes a combination of main memory and disk storage. Also, the in-memory database may support real-time analytics and transactional processing including replication and aggregation techniques. Also, within the in-memory database environment, calculation logic is pushed down into the database layer (as opposed to residing in the application layer) such that the processing time for querying and manipulating the data within the database may be reduced as compared with conventional relational database. In some examples, the in-memory database may be HANA® Enterprise 1.0 (or any other versions). However, the techniques described herein may be applied to any type of relational database as well.

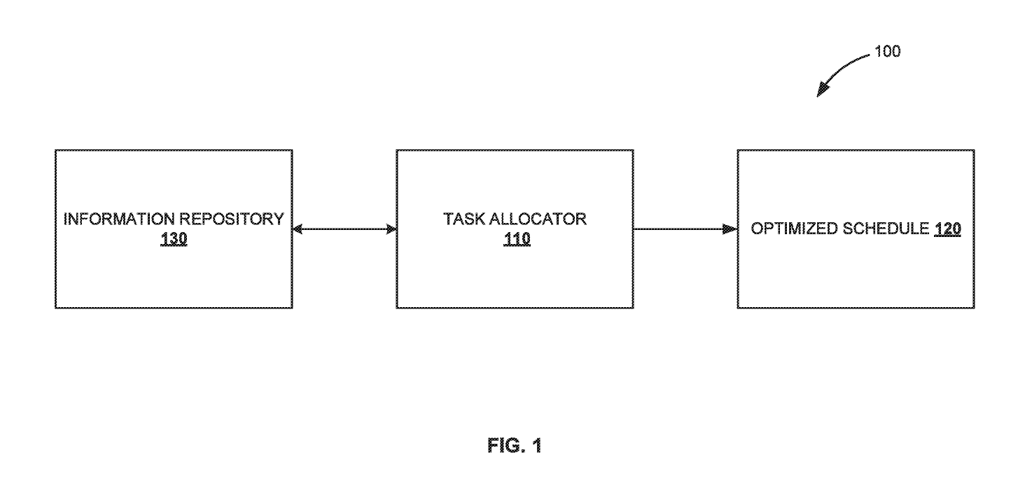

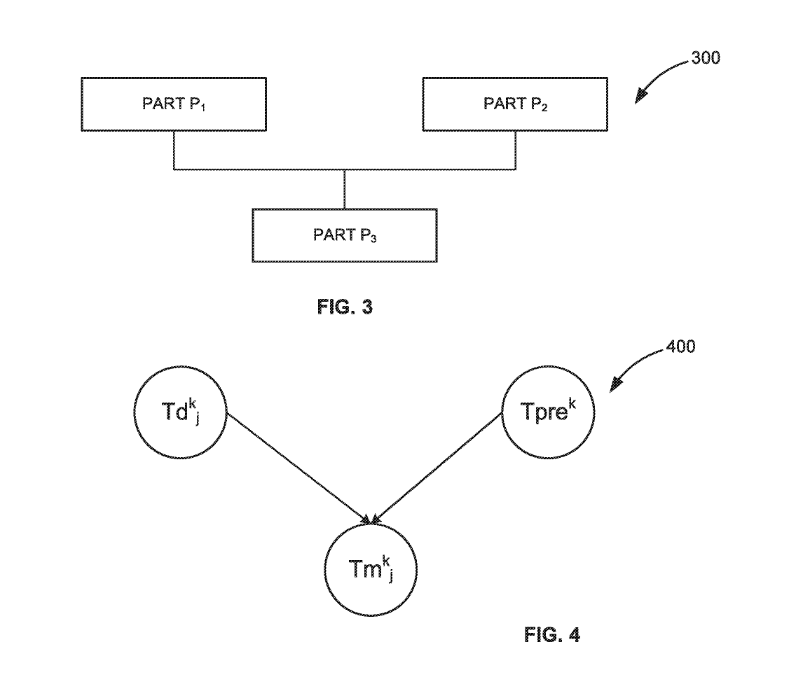

FIG. 1 is a block diagram illustrating exemplary system 100 including task allocator 110 for optimizing tasks allocation in distributed manufacturing environment, according to an embodiment. The system 100 includes the task allocator 110 for generating optimized schedule 120 for assigning tasks to various vendors or suppliers for manufacturing products to fulfill an order. The task allocator 110 reads various data related to the order, the products, and suppliers from information repository 130. The data related to the order may include quantity of products to be manufactured, timeline to fulfill the order, etc., the data related to the product may include information about various components of the product, the materials required to manufacture each component, etc., and the data related to suppliers include information about suppliers such as stock of available materials with suppliers, capital cost of components quoted by suppliers, manufacturing time of components quoted by suppliers, etc, in an embodiment, the data related to the product may be read from a bill-of-material (BOM) stored in the information repository 130. Based upon the read data, the task allocator 110 generates the optimized schedule 120 to distribute tasks of manufacturing various components of the product to various suppliers such that to minimize product cost and maximize profit. In an embodiment, the task allocator 110 utilizes linear programing method and graphical topology to generate the optimized schedule 120. The generation of the optimized schedule 120 is described in detail with reference to FIGS. 3-6. In an embodiment, when there is any change in the data of the information repository 130, the task allocator 110, based upon the updated data, dynamically updates the optimized schedule 120 to optimize task allocation and maximize profit based upon the updated data. The tasks may be re-assigned or re-allocated based upon the updated optimized planning schedule.

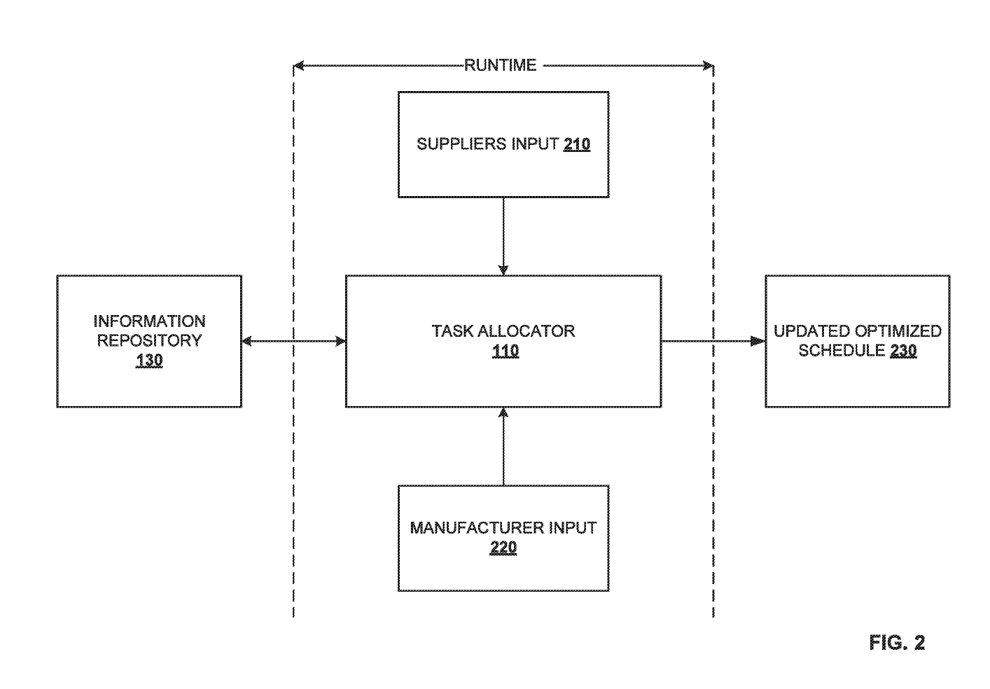

FIG. 2 is a block diagram illustrating various dynamic or runtime inputs (e.g., suppliers input 210 and manufacturer input 220) provided to the task allocator 110 for updating task assignment or optimized planning schedule (e.g., the optimized schedule 120 of FIG. 1). The inputs 210-220 may be constraint(s) provided by the suppliers and/or manufacturer during runtime. For example, the suppliers input 210 may be a runtime constraints such as manufacturing unit shutdown for 10 days due to emergency and there would be delay of 10 days. Similarly, the manufacturer input 220 may be, e.g., change in tolerable delay. In an embodiment, based upon the inputs 210-220 and/or data from the information repository 130, the task allocator 110 updates the optimized planning schedule. For example, the task allocator 110 updates the optimized schedule 120 to dynamically generate updated optimized planning schedule 230. Therefore, due to unforeseen circumstances or emergency circumstance, new constraints may be formed and provided to the task allocator 110 during runtime to dynamically update and optimize schedule based upon changing circumstances. Based upon the updated optimized planning schedule 230, the manufacturer may re-assign the tasks to various suppliers to ensure maximum profit despite unfavorable and changing circumstance. In an embodiment, some non-changing inputs or constraints may be predefined and stored within the information repository 130.

The task allocator 110 generates and/or updates the optimized planning schedule (e.g., the optimized schedule 120 of FIG. 1) based upon the product (ordered product) manufacturing topology and applying linear programming.

FIG. 3 is a block diagram illustrating an exemplarily manufacturing topology 300 of a product ‘A’ comprising three components or parts P₁, P₂, and P₃, according to an embodiment. The manufacturing topology 300 indicates the components P₁, P₂, and P₃ as nodes or blocks and their manufacturing dependency or connection through edges. Therefore, an edge in the manufacturing topology represents manufacturing dependency between the components or parts P₁, P₂, and P₃ of the product A. For example, the manufacturing topology 300 indicates that components or parts P₁ and P₂ may be manufactured independently, i.e., the manufacturing of the components or parts P₁ and P₂ is independent of any other component (i.e., the nodes representing the components P₁ and P₂ do not have any predecessor node or components) whereas the manufacturing of the component P₃ is dependent upon the components P₁ and P₂ as the component P₃ has predecessor nodes P₁ and P₂. The manufacturing topology 300 of the product A is generated by reading data related to the product A from the information repository.

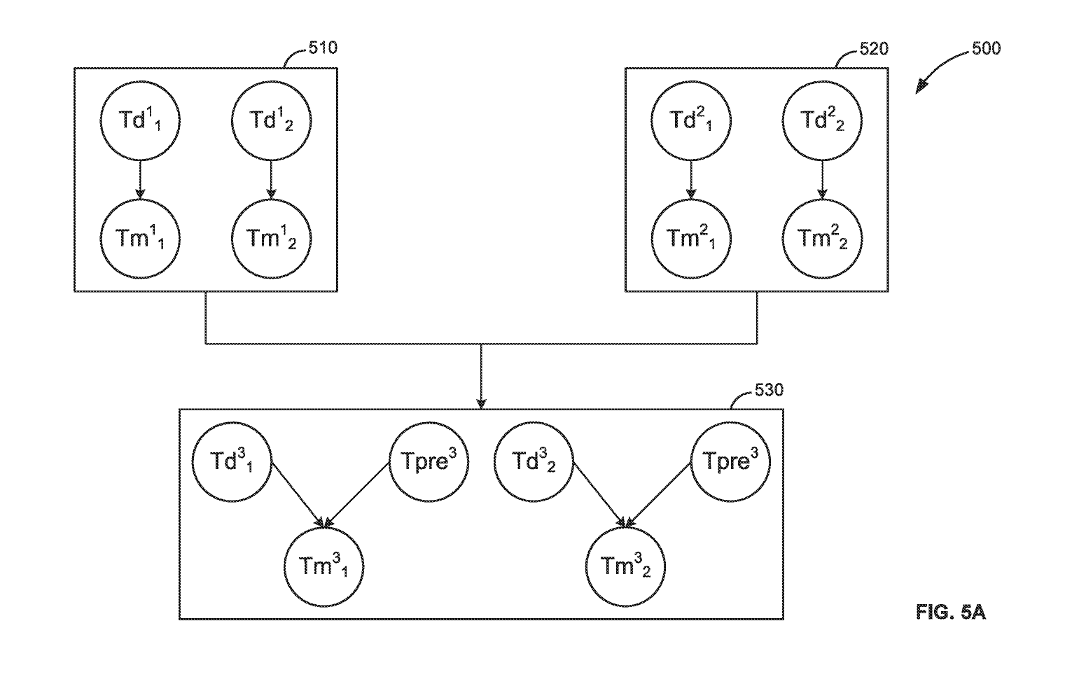

Based upon the production or manufacturing topology of the product (e.g., the manufacturing topology 300 of the product A) and applying linear programming the task allocator 110 generates an optimized planning schedule (e.g., the optimized schedule 120 of FIG. 1) as described with reference to FIG. 4 to FIG. 6. Prior to applying the linear programming various functions and equations used by the task allocator 110 may be described considering below generic scenario:

### Scenario:

Suppose an order for product is received by a manufacturer. The product may comprise N parts, which may be represent by Pₖ(k=1, 2, . . . , N). Each product of the order needs N_{Pk} units of Pₖ and Pₖ is made up of materials of mᵢ^{k}(i=1, 2, . . . , Nₖ), Nₖ is the total kinds of materials to manufacture part Pₖ. Each Pₖ need Gᵢ^{k} units of mᵢ^{k}. Part Pₖ may has several vendors or suppliers, which contains Vⱼ^{k}, NVₖ is the total number of part Pₖ's vendor. Vendor Vⱼ^{k}(j=1, 2, . . . , NVₖ) has a stock of gᵢ^{kj} units mᵢ^{k}. The manufactural cost of each part Pₖ with materials of vendor Vⱼ^{k} is Cmⱼ^{k}, which means the vendors should provide materials. The manufactural cost of each part Pₖ without materials of vendor Vⱼ^{k} is Cⱼ^{k}, the average transportation cost of each part Pₖ of vendor Vⱼ^{k} is Ctⱼ^{k}. xⱼ^{k} represents the number of Pₖ with materials for vendor Vⱼ^{k} to manufacture, yⱼ^{k} represents the number of Pₖ without materials for vendor Vⱼ^{k} to manufacture.

Based upon the above scenario, the functions and equations that may be used by the task allocator 110 in generating optimized planning schedule may be:

(i) Capital cost of the product:— The capital cost of the product includes the production cost and the transportation cost. The capital cost of the product may be determined by: (a) determining capital cost of each part Pₖ by applying the below equation:

C_{Pk}=Σⱼ₌₁^{NV}^{ₖ}[(Cmⱼ^{k}+Ctⱼ^{k})xⱼ^{k}+(Cⱼ^{k}+Ctⱼ^{k})yⱼ^{k}]

and (b) determining the total capital cost of the product by summarizing the capital cost of all parts or components of the product, e.g., by using the below equation:

C=Σₖ₌₁^{N}C_{Pk}

(ii) Manufacturing time of the product:— The manufacturing time of the product may be calculated by: (a) determining average time required to produce a unit of part Pₖ of vendor Vⱼ^{k} i.e., Tpⱼ^{k}, the average time required to transport a unit of part Pₖ of vendor Vⱼ^{k} i.e., Ttⱼ^{k}, and the time required to wait for of vendor Vⱼ^{k} to start (from receiving order to starting manufacturing) i.e., Tdⱼ^{k}; (b) determining time to complete the order of vendor Vⱼ^{k} for part Pₖ as manufacturing of some parts can be dependent on other parts (i.e., the manufacturing of same parts can be started after manufacturing of some other parts have been completed, so the time to complete the order of vendor Vⱼ^{k} for part Pₖ may be calculated using the below equations:

Tⱼ^{k}=Tmⱼ^{k}+Twⱼ^{k}

Tmₖ^{k}=(Tpⱼ^{k}+Ttⱼ^{k})(xⱼ^{k}+yⱼ^{k})

Twⱼ^{k}=max(Tdⱼ^{k},Tpre^{k})

“where Tpre^{k} represents the latest complete time (the order from receiving to closing) of the parts which part Pₖ is based, if Pₖ isn't dependent upon any other parts, Tpre^{k}=0;”
and (c) determining a total manufacturing time for part Pₖ by using the below equation:

T^{k}=max(Tⱼ^{k})

Using the above functions or equations, the product manufacturing topology (e.g., the manufacturing topology 300 of the product A), the suppliers data, and applying the linear programming, the task allocator 110 generates the optimized planning schedule. The generation of the optimized planning schedule may be described with reference to FIG. 3 to FIG. 6.

Referring back to FIG. 3, the product A comprises three parts, P₁, P₂, and P₃ such that manufacturing of the part P₃ is dependent upon the parts P₁ and P₂ (i.e., Tpre³=max(T¹, T²)). The task allocator 110 reads the product A data from the information repository (e.g., the information repository 130 of FIG. 1). In an embodiment, the product data such as components or parts of the product and material(s) required to make each part, etc., may be read from BOM. In an embodiment, the product data may be read from a database table stored in the information repository 130. An exemplarily product database table namely PRODUCT_TABLE may be as shown below:

PRODUCT_TABLE:

| PARTS | MATERIALS |
|---|---|
| P₁ | m₁¹, m₂¹, m₃¹ |
| P₂ | m₁², m₂² |
| P₃ | m₁³, m₂³ |

Each product A of the order may contain 1 unit of P₁, 2 units of P₂, 1 unit of P₃. Further, as shown in the PRODUCT_TABLE, P₁ is made up of 3 kinds of materials m₁¹, m₂¹, m₃¹, part P₂ is made up of 2 kinds of materials m₁², m₂², and P₃ is made up of 2 kinds of materials m₁³, m₂³.

Once the product data is read, the task allocator 110 reads the suppliers or vendors data such as stock of available materials, capital cost of one or more parts of the product, manufacturing time of one or more parts of the product, etc. The suppliers data may be read from a database table stored in the information repository. An exemplarily supplier database table namely VENDOR_TABLE may be as shown below:

VENDOR_TABLE:

| | | STOCK OF | | | CAPITAL COST | | | MANUFACTURING TIME | | |
|---|---|---|---|---|---|---|---|---|---|---|
| PARTS | VENDOR | MATERIALS | | | OF EACH PART | | | OF EACH PART | | |
| P1 | V₁¹ | g₁¹¹ | g₂¹¹ | g₃¹¹ | Cm₁¹ | C₁¹ | Ct₁¹ | Tp₁¹ | Tt₁¹ | Td₁¹ |
| | V₂¹ | g₁¹² | g₂¹² | g₃¹² | Cm₂¹ | C₂¹ | Ct₂¹ | Tp₂¹ | Tt₂¹ | Td₂¹ |

| | | | | | | | | | |
|---|---|---|---|---|---|---|---|---|---|
| P2 | V₁² | g₁²¹ | g₂²¹ | Cm₁² | C₁² | Ct₁² | Tp₁² | Tt₁² | Td₁² |
| | V₂² | g₁²² | g₂²² | Cm₂² | C₂² | Ct₂² | Tp₂² | Tt₂² | Td₂² |
| P3 | V₁³ | g₁³¹ | g₂³¹ | Cm₁³ | C₁³ | Ct₁³ | Tp₁³ | Tp₁³ | Td₁³ |
| | V₂³ | g₁³² | g₂³² | Cm₂³ | C₂³ | Ct₂³ | Tp₂³ | Tt₂³ | Td₂³ |

As read from the VENDOR_TABLE, parts P₁, P₂, and P₃ have two vendors. Once the task allocator 110 reads the suppliers data (e.g., from the VENDOR_TABLE) and identifies the manufacturing topology 300 of the product A, the task allocator 110 determines the manufacturing time of the product A by the latest complete parts, using the below equation:

T=max(T^{k})

As the manufacturing time of the component represented by the node Pₖ is determined based on its' precursor or predecessor node, so the node without precursor node may have the largest value of total manufacturing time. Therefore, the time T may be redefined as:

T=max(T^{k})

(where k is set as the values of parts' labels whose node not have precursor nodes. And for the product A, T_{A}=T³

Once the manufacturing cost and time of the product A is determined by the task allocator 110, the task allocator 110 applies linear programming to normalize the determined manufacturing cost and time of the product A. In an embodiment, different customers or manufacturers may have different priority for ‘manufacturing cost’ and ‘manufacturing time’, e.g., some manufacturer may want to hit the market at the earliest without much consideration of the manufacturing cost manufacturing time is more critical), therefore, the manufacturer may assign different weight/weightage to the manufacturing cost and time of the product. Once the manufacturing cost and time of the product A is determined by the task allocator 110 (e.g., based upon the respective weight of the manufacturing cost and lime provided by the manufacturer), the task allocator 110 normalize the manufacturing cost and time (e.g., using linear programming to move them to the same scale). In an embodiment, to find an optimal and reasonable task assignment solution, the constant in the formula does not affect the result of the optimal solution, so the constant in the formula may be removed and the coefficients of the variables in the below equations are normalized separately:

C=Σₖ₌₁^{N}C_{Pk}

T=max(T^{k})

Once the normalization is completed, the task allocator 110 calculates the total cost of product or product cost by using the below equation:

Cnor=w_{C}C^{norm}+w_{T}T^{norm}

s.t.w_{C}+w_{T}=1

w_{C},w_{T}≥0

C^{norm} is the result of C without constant and coefficient normalized. T^{norm} is the result of T without constant and coefficient normalized, w_{C} is the weight of C^{norm}, w_{T} is the weight of T^{norm}, w_{C}, w_{T} is provided by customer/manufacturer. In an embodiment, the above calculation uses scaling method with the below equation to normalize:

$${X}_{n}^{norm} = \frac{{X}_{n}}{Σ {X}_{n}}$$

(where Xₙ is the original data. Σ Xₙ is the summary of Xₙ).

The task allocator 110 minimize the product cost or equation Cnorm. In an embodiment, the value of xⱼ^{k} and yⱼ^{k} may be determined with the linear programming with considering some constrains such as the number of parts produced by all the vendors matches the order represent by the equation Σⱼ₌₁^{NV}^{ₖ}(xⱼ^{k}+yⱼ^{k})=NₚN_{Pk} (where: Nₚ indicates the quantity of product requirements in the order,

$${x}_{j}^{k} \leq min ( \frac{{g}_{i}^{kj}}{{G}_{i}^{k}} ) ,$$

and xⱼ^{k}, yⱼ^{k}≥0) and the task for vendor Vⱼ^{k} not to be more than it can supply or bare, e.g., the number of Pₖ with materials for vendor Vⱼ^{k} to manufacture should be less than the stock, (e.g., represent by the equation

$${x}_{j}^{k} \leq min ( \frac{{g}_{i}^{kj}}{{G}_{i}^{k}} ) ) .$$

In an embodiment, the product or capital cost C is determined with variables xⱼ^{k}, yⱼ^{k} using the below equations:

C_{Pk}=Σⱼ₌₁^{NV}^{ₖ}[(Cmⱼ^{k}+Ctⱼ^{k})xⱼ^{k}+(Cⱼ^{k}+Ctⱼ^{k})yⱼ^{k}]

C=Σₖ₌₁^{N}C_{Pk}

The manufacturing time T of the product may be determined using the manufacturing topology of the product and below equations:

Twⱼ^{k}=max(Tdⱼ^{k},Tpre^{k})

T^{k}=max(Tⱼ^{k})

T=max(T^{k})

In an embodiment, the manufacturing time of the product may be determined using supplier's or vendor's time topology. FIG. 4 illustrates a generic supplier's or vendor's timeline topology 400, according to an embodiment. The supplier's or vendor's timeline topology 400 is illustrated for vendor Vⱼ^{k}. The vendor's timeline topology 400 indicates three types of timeline to be considered by any vendor or supplier (e.g., Tdⱼ^{k}, Tmⱼ^{k}, and Tpre^{k}) for any product/component. Tmⱼ^{k} indicates total manufacturing time of part Pₖ by the vendor Vⱼ^{k}. In an embodiment, the Tmⱼ^{k} is aggregate of average time required to produce a unit of part Pₖ i.e., Tpⱼ^{k} and the average time required to transport a unit of part Pₖ, i.e., Ttⱼ^{k}. Tpre^{k} represents the latest complete time (the order from receiving to closing) of the parts on which part Pₖ is based, if Pₖ isn't based on any other parts, Tpre^{k}=0. Tdⱼ^{k} indicates the time required to wait to start (from receiving order to starting manufacturing) i.e., Tdⱼ^{k}. Therefore, Tdⱼ^{k} and Tpre^{k} are waiting time whereas Tmⱼ^{k} indicates manufacturing time of the part/component.

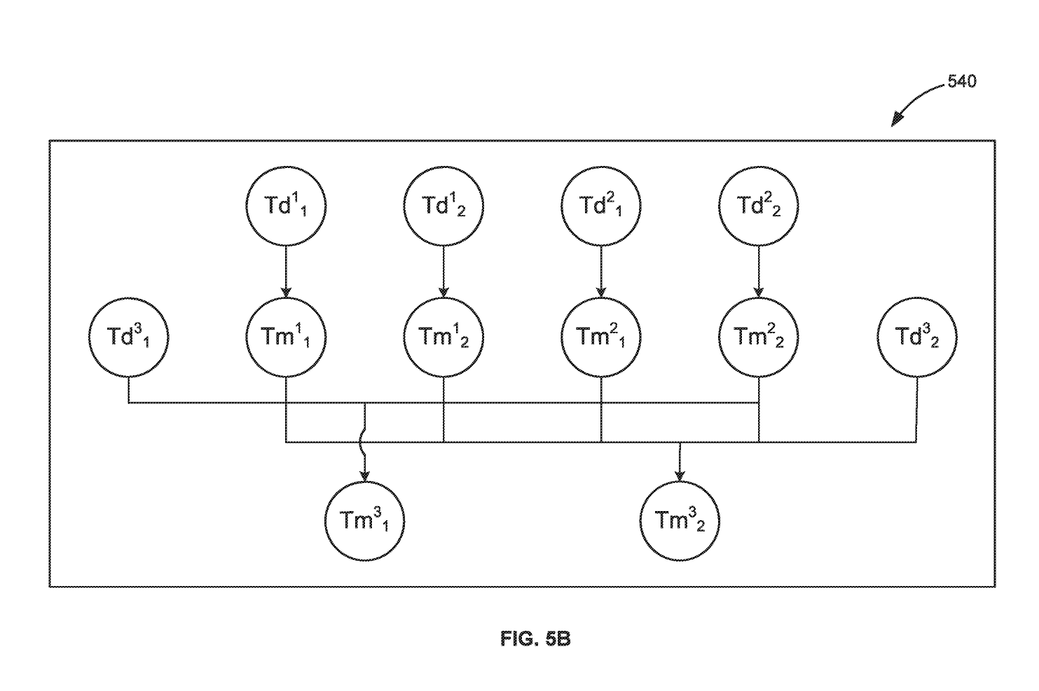

In an embodiment, using the generic supplier timeline topology (e.g., the generic supplier timeline topology 400 of FIG. 4) and the manufacturing topology of the product (e.g., the manufacturing topology 300 of the product of FIG. 3), supplier's timeline topology of the product is generated. FIG. 5A illustrates supplier's timeline topology 500 of the product A to determine optimal manufacturing time of the product, according to an embodiment. The task allocator 110 replaces nodes P₁, P₂, and P₃ of FIG. 3 with their respective vendor's or supplier's timeline topology to generate supplier's timeline topology 500 of the product A. Each node (P₁, P₂, and P₃) is replaced by supplier's timeline topology 510, 520, and 530 of respective components or parts P₁, P₂, and P₃ to generate supplier's timeline topology 500 of the product A. The supplier's timeline topology 510 and 520 of the parts P₁ and P₂ do not include Tpre as the manufacturing of the parts P₁ and P₂ is not dependent upon other parts, whereas the supplier's timeline topology 530 of the part P₁ includes Tpre³ as the manufacturing of the part P₃ is dependent upon the parts P₁ and P₂. Once the nodes are replaced by the respective supplier's timeline topology, the supplier's timeline topology 500 of the product A is generated. The task allocator 110 merges the generated supplier's timeline topology 500 of the product A with the relationship of Tpre^{k} same node to generate production timeline topology 540 (FIG. 5B) of the product A. In an embodiment, the redundant or duplicate nodes are removed to generate production timeline topology 540 of the product A.

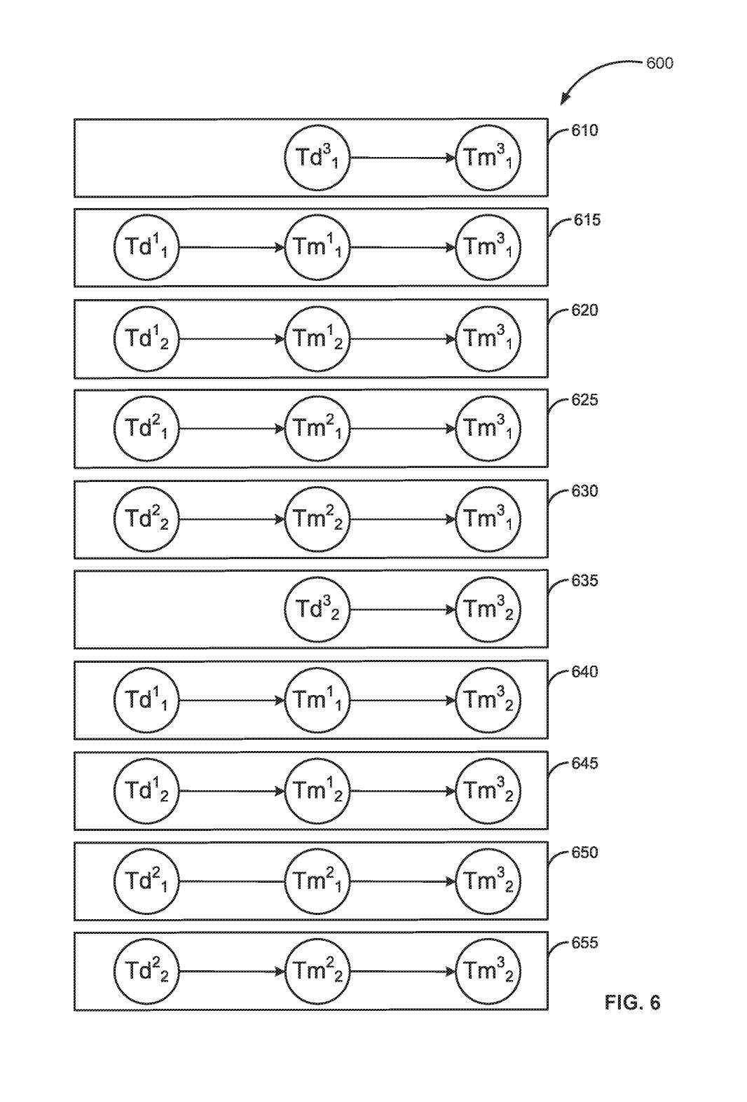

Once the production timeline topology 540 of the product A is generated, the task allocator 110 determines all routes from nodes without predecessor node(s) to nodes without successor nodes in the production timeline topology 540. FIG. 6 illustrates various nodal routes or paths (e.g., 610, 615, 620, 625, 630, 635, 640, 645, 650, and 655) from nodes without predecessor node(s) to nodes without successor nodes in the production timeline topology 540 of the product A. Once the paths 610, 615, 620, 625, 630, 635, 640, 645, 650, and 655 is determined, the task allocator 110 calculates total manufacturing cost of the product A for each determined path 610, 615, 620, 625, 630, 635, 640, 645, 650, and 655 separately. In an embodiment, the task allocator 110 calculates normalized total manufacturing cost of the product A for each determined path 610, 615, 620, 625, 630, 635, 640, 645, 650, and 655 separately.

In an embodiment, the task allocator 110 applies the below mentioned equations to determine the total manufacturing time of the product for each path, total manufacturing cost, and the normalized total manufacturing cost for each path. For example, for the path 610, the total manufacturing time of product A can be expressed by the below equation:

T_{A}=T³=T₁³=Tm₁³+Td₁³=(Tp₁³+Tt₁³)(x₁³+y₁³)+Td₁³

and the normalization of T_{A} by below equation:

T_{A}^{norm}=0.5x₁³+0.5y₁³

the total capital cost of product A can be expressed by the below equation:

C_{A}=(Cm₁¹+Ct₁¹)x₁¹+(C₁¹+Ct₁¹)y₁¹+(Cm₂¹+Ct₂¹)+x₂¹+(C₂¹+Ct₂¹)y₂¹+(Cm₁²+Ct₁²)x₁²+(C₁²+Ct₁²)y₁²+(Cm₂²+Ct₂²)x₂²+(C₂²+Ct₂²)y₂²

the sum of all coefficients in the equation can be calculated as:

S_{COE}=(Cm₁¹+Ct₁¹)+(C₁¹+Ct₁¹)+(Cm₂¹+Ct₂¹)+(C₂¹+Ct₂¹)+(Cm₁²+Ct₁²)+(C₁²+Ct₁²)+(Cm₂²+Ct₂²)+(C₂²+Ct₂²)

the normalization of C_{A} can be expressed by:

$${C}_{A}^{norm} = \frac{( {Cm}_{1}^{1} + {Ct}_{1}^{1} )}{{s}_{COE}} {x}_{1}^{1} + \frac{( {C}_{1}^{1} + {Ct}_{1}^{1} )}{{s}_{COE}} {y}_{1}^{1} + \frac{( {Cm}_{2}^{1} + {Ct}_{2}^{1} )}{{s}_{COE}} {x}_{2}^{1} + \frac{( {C}_{2}^{1} + {Ct}_{2}^{1} )}{{s}_{COE}} {y}_{2}^{1} + \frac{( {Cm}_{1}^{2} + {Ct}_{1}^{2} )}{{s}_{COE}} {x}_{1}^{2} + \frac{( {C}_{1}^{2} + {Ct}_{1}^{2} )}{{s}_{COE}} {y}_{1}^{2} + \frac{( {Cm}_{2}^{2} + {Ct}_{2}^{2} )}{{s}_{COE}} {x}_{2}^{2} + \frac{( {C}_{2}^{2} + {Ct}_{2}^{2} )}{{s}_{COE}} {y}_{2}^{2}$$

the total cost of product A after normalization can be represent by the below equation:

Cₙₒᵣₘ=w_{C}C_{A}^{norm}+w_{T}T_{A}^{norm}

In order to get the minimize Cₙₒᵣₘ, the below equations may be used with Cₙₒᵣₘ subject to:

$${\sum }_{j = 1}^{{NV}_{k}} ( {x}_{j}^{k} + {y}_{j}^{k} ) = {N}_{A} {N}_{Pk} ( N = 3 )$$

$${x}_{j}^{k} \leq min ( \frac{{g}_{i}^{kj}}{{G}_{i}^{k}} ) ( N = 3 , {N}_{1} = 3 , {N}_{2} = 2 , {N}_{3} = 2 , {NV}_{1} = 2 , {NV}_{2} = 2 , {NV}_{3} = 2 )$$

$${x}_{j}^{k} , {y}_{j}^{k} \geq 0 ( N = 3 , {NV}_{1} = 2 , {NV}_{2} = 2 , {NV}_{3} = 2 )$$

$${Td}_{1}^{3} \geq {Td}_{1}^{1} + {Tm}_{1}^{1} , {Td}_{2}^{1} + {Tm}_{2}^{1} , {Td}_{1}^{2} + {Tm}_{1}^{2} , {Td}_{2}^{2} + {Tm}_{2}^{2}$$

$${Td}_{1}^{3} + {Tm}_{1}^{3} \geq {Td}_{1}^{1} + {Tm}_{1}^{1} + {Tm}_{2}^{3} , {Td}_{2}^{1} + {Tm}_{2}^{1} + {Tm}_{2}^{3} , {Td}_{1}^{2} + {Tm}_{1}^{2} + {Tm}_{2}^{3} , {Td}_{2}^{2} + {Tm}_{2}^{2} + {Tm}_{2}^{3}$$

$${Td}_{1}^{3} + {Tm}_{1}^{3} \geq {Td}_{2}^{3} + {Tm}_{2}^{3}$$

Once the total manufacturing cost and the normalized total manufacturing cost for each path (e.g., the path 610, 615, 620, 625, 630, 635, 640, 645, 650, and 655) is determined/calculated. The path with the minimum total manufacturing cost or the minimum normalized total manufacturing cost may be selected as the optimal path by the task allocator 110. The selected optimal path may be used for generating the optimal programming schedule. In an embodiment, the optimal programming schedule includes the schedule to allocate/assign tasks for various suppliers based upon the optimal path selected by the task allocator 110. For example, if the path 655, i.e., Td₂²->Tm₂²->Tm₂³ has the minimum total manufacturing cost or minimum normalized total manufacturing cost then the optimal programming schedule includes the schedule based upon the path 655. Based upon the generated optimal programming schedule, the manufacturing tasks is assigned to the one or more vendors, e.g., based upon the selected path Td₂²->Tm₂²->Tm₂³, the manufacturing of the components or parts P₁, P₂, P₃ of the product A may be assigned to the vendor 2.

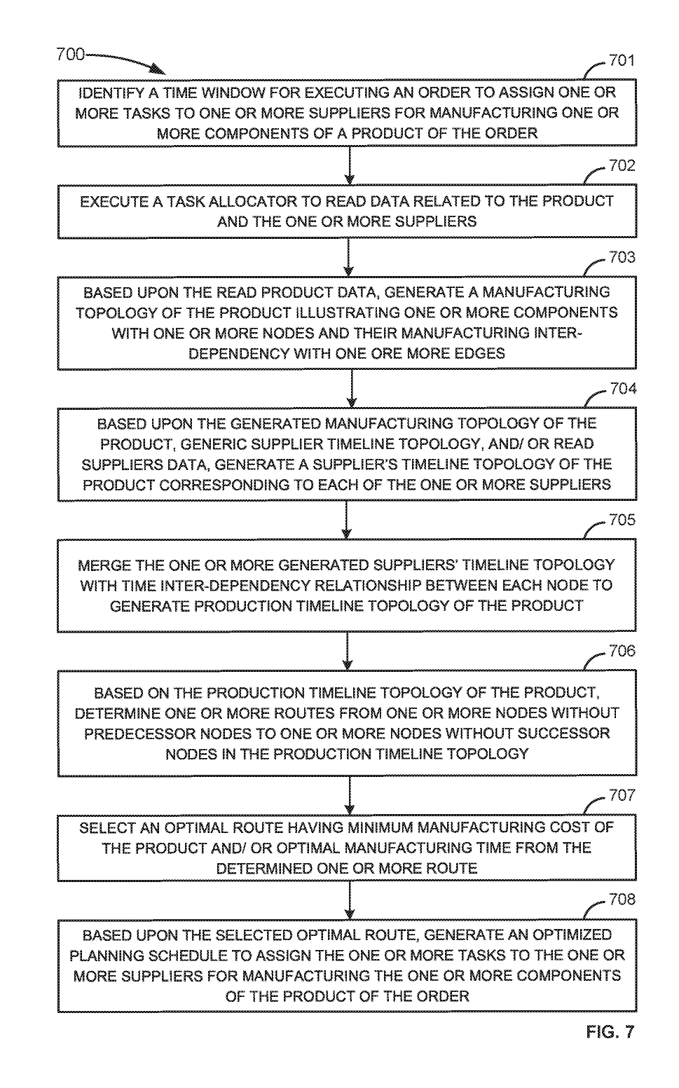

FIG. 7 is a flowchart illustrating a process 700 for optimizing task allocation in distributed manufacturing environment, according to an embodiment. At 701, a time window for executing an order is identified to assign one or more tasks to one or more suppliers for manufacturing one or more components of a product of the order in a distributed manufacturing environment. At 702, a task allocator (e.g., the task allocator 110 of FIG. 1) is executed to read data related to the product and the one or more suppliers. In an embodiment, the product data may be read from bill-of-material (BOM) and the suppliers data may be read from suppliers database table stored in information repository (e.g., the information repository 130 of FIG. 1). At 703, based upon the read product data, a manufacturing topology of the product (e.g., the manufacturing topology 300 of FIG. 3) illustrating the one or more components of the product with one or more nodes and their manufacturing inter-dependency with one or more edges is generated. At 704, based upon the generated manufacturing topology (e.g., the manufacturing topology 300 of FIG. 3) of the product and generic supplier's timeline topology (e.g., the generic supplier's timeline topology 400 of FIG. 4) and/or the read suppliers data, a supplier's timeline topology of the product (e.g., the supplier's timeline topology of the product 500 of FIG. 5A) is generated. The supplier's timeline topology of the product indicates time quoted by each supplier to manufacture the respective component of the respective node. In an embodiment, the supplier's timeline topology of the product is generated by replacing the one or more nodes of the manufacturing topology with respective one or more nodes of each of the supplier's timeline topology for that component of the respective node. At 705, the one or more generated suppliers' timeline topology are merged with time inter-dependency relationship between each node to generate production timeline topology of the product (e.g., the production timeline topology of the product 540 of the FIG. 5B). In an embodiment, merging the one or more generated suppliers' timeline topology with tune inter-dependency relationship between each node further comprises removing redundant nodes. At 706, based on the production timeline topology of the product (e.g., the production timeline topology of the product 540 of the FIG. 5B), one or more routes from one or more nodes without predecessor nodes to one or more nodes without successor nodes (e.g., the routes 610, 615, 620, 625, 630, 635, 640, 645, 650, and 655) in the production timeline topology is determined. At 707, an optimal route having minimum manufacturing cost of the product and/or optimal manufacturing time from the determined one or more route is selected. At 708, based upon the selected optimal route, an optimized planning schedule is generated to assign the one or more tasks to the one or more suppliers for manufacturing the one or more components of the product of the order.

In an embodiment, a manufacturer may input the number of products needed and the weight of capital cost and weight of manufacturing time, the vendors or suppliers may input stock of materials for one or more parts of the product, capital cost of each part, and manufacturing time of each part, and a system administrator may enter a detailed information of the products, such as the parts it consisted of, the vendor of each part, the quality of material each part needed. Based upon the manufacturer input, the suppliers input, and the system administrator input, the task allocator automatically and dynamically determines an optimal tasks assignment to various vendor or supplier to fulfill an order based upon linear programming.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code; such as produced by a compiler; and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

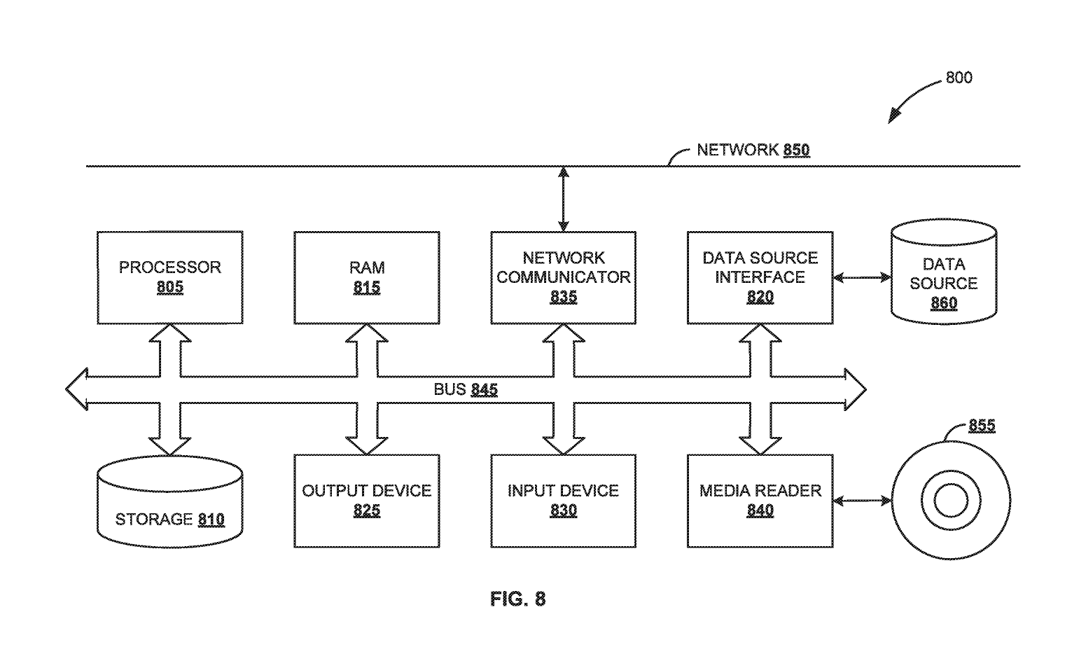

FIG. 8 is a block diagram of an exemplary computer system 800. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. The output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments, the data source 860 may be accessed via an abstraction layer, such as, a semantic layer

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer-readable medium to store instructions, which when executed by a computer, causes the computer to:
identify a time window for executing an order to assign one or more tasks to one or more suppliers for manufacturing one or more components of a product of the order in a distributed manufacturing system; and
for the identified time window, execute a task allocator to:
read data related to the product and the one or more suppliers;
based upon the read product data, generate a manufacturing topology of the product illustrating the one or more components with one or more nodes and their manufacturing inter-dependency with one or more edges;
based upon the generated manufacturing topology of the product and the read one or more suppliers data, generate a supplier's timeline topology of the product corresponding to each of the one or more suppliers by:
replacing the one or more nodes of the manufacturing topology with respective one or more nodes illustrating time quoted by the supplier to manufacture the respective component of the respective node;
merge one or more generated suppliers' timeline topology with time inter-dependency relationship between each node to generate production timeline topology of the product;
based on the production timeline topology of the product, determine one or more routes from one or more nodes without predecessor nodes to one or more nodes without successor nodes in the production timeline topology;
select an optimal route having minimum manufacturing cost of the product and optimal manufacturing time from the determined one or more route; and
based upon the selected optimal route, generate an optimized planning schedule to assign the one or more tasks to the one or more suppliers for manufacturing the one or more components of the product of the order.

2. The computer-readable medium of claim 1, wherein the data related to the product includes information of one or more components comprising the product, one or more materials for manufacturing each component, and quantity of the product quoted in the order.

3. The computer-readable medium of claim 1, wherein the data related to the one or more suppliers include information about one or more suppliers, stock of materials available with the one or more suppliers, manufacturing cost of the one or more components as quoted by the one or more suppliers, and manufacturing time of the one or more components as quoted by the one or more suppliers.

4. The computer-readable medium of claim 1, wherein the product data is read from a bill-of-material (BOM) and the one or more supplier data is read from a database table maintaining the one or more supplier data.

5. The computer-readable medium of claim 1, wherein merging the one or more generated suppliers' timeline topology with time inter-dependency relationship between each node further comprises removing redundant nodes.

6. The computer-readable medium of claim 1, wherein selecting the optimal route further comprises:
determining a total capital cost of the product for each of the determined one or more routes;
normalizing the determined total capital cost of the product for each of the determined one or more routes;
determining manufacturing time of the product for each of the determined one or more routes;
normalizing the determined manufacturing time of the product for each of the determined one or more routes; and
selecting the route having minimum normalized total capital cost and minimum normalized manufacturing time as the optimal route.

7. The computer-readable medium of claim 6, wherein the normalization is done using linear programming.

8. The computer-readable medium of claim 1 further comprises instructions which when executed by the computer further causes the computer to:
receive one or more runtime constraints from at least one of the manufacturer and the one or more suppliers;
based upon the received one or more runtime constraints, update the optimized planning schedule; and
based upon the updated optimized planning schedule, re-assign the one or more tasks to the one or more suppliers.

9. A computer-implemented method comprising:
identifying a time window for executing an order to assign one or more tasks to one or more suppliers for manufacturing one or more components of a product of the order in a distributed manufacturing system; and
for the identified time window, executing a task allocator to:
read data related to the product and the one or more suppliers;
based upon the read product data, generate a manufacturing topology of the product illustrating the one or more components with one or more nodes and their manufacturing inter-dependency with one or more edges;
based upon the generated manufacturing topology of the product and the read one or more suppliers data, generate a supplier's timeline topology of the product corresponding to each of the one or more suppliers by:
replacing the one or more nodes of the manufacturing topology with respective one or more nodes illustrating time quoted by the supplier to manufacture the respective component of the respective node;
merge one or more generated suppliers' timeline topology with time inter-dependency relationship between each node to generate production timeline topology of the product;
based on the production timeline topology of the product; determine one or more routes from one or more nodes without predecessor nodes to one or more nodes without successor nodes in the production timeline topology;
select an optimal route having minimum manufacturing cost of the product and optimal manufacturing time from the determined one or more route; and
based upon the selected optimal route, generate an optimized planning schedule to assign the one or more tasks to the one or more suppliers for manufacturing the one or more components of the product of the order.

10. The computer-implemented method of claim 9, wherein merging the one or more generated suppliers' timeline topology with time inter-dependency relationship between each node further comprises removing redundant nodes.

11. The computer-implemented method of claim 9 further comprising:
determining a total capital cost of the product for each of the determined one or more routes;
normalizing the determined total capital cost of the product for each of the determined one or more routes;
determining manufacturing time of the product for each of the determined one or more routes;
normalizing the determined manufacturing time of the product for each of the determined one or more routes; and
selecting the route having minimum normalized total capital cost and minimum normalized manufacturing time as the optimal route.

12. The computer-implemented method of claim 9 further comprising:
receiving one or more runtime constraints from at least one of the manufacturer and the one or more suppliers;
based upon the received one or more runtime constraints, updating the optimized planning schedule; and
based upon the updated optimized planning schedule, re-assign the one or more tasks to the one or more suppliers.

13. A computer system comprising:
at least one memory to store executable instructions; and
at least one processor communicatively coupled to the at least one memory, the at least one processor configured to execute the executable instructions to:
identify a time window for executing an order to assign one or more tasks to one or more suppliers for manufacturing one or more components of a product of the order in a distributed manufacturing system; and
for the identified time window, execute a task allocator to:
read data related to the product and the one or more suppliers;
based upon the read product data, generate a manufacturing topology of the product illustrating the one or more components with one or more nodes and their manufacturing inter-dependency with one or more edges;
based upon the generated manufacturing topology of the product and the read one or more suppliers data, generate a supplier's timeline topology of the product corresponding to each of the one or more suppliers by:
replacing the one or more nodes of the manufacturing topology with respective one or more nodes illustrating time quoted by the supplier to manufacture the respective component of the respective node;
merge one or more generated suppliers' timeline topology with time inter-dependency relationship between each node to generate production timeline topology of the product;
based on the production timeline topology of the product, determine one or more routes from one or more nodes without predecessor nodes to one or more nodes without successor nodes in the production timeline topology;
select an optimal route having minimum manufacturing cost of the product and optimal manufacturing time from the determined one or more route; and
based upon the selected optimal route, generate an optimized planning schedule to assign the one or more tasks to the one or more suppliers for manufacturing the one or more components of the product of the order.

14. The system of claim 13, wherein the data related to the product includes information of one or more components comprising the product, one or more materials for manufacturing each component, and quantity of the product quoted in the order.

15. The system of claim 13, wherein the data related to the one or more suppliers include information about one or more suppliers, stock of materials available with the one or more suppliers, manufacturing cost of the one or more components as quoted by the one or more suppliers, and manufacturing time of the one or more components as quoted by the one or more suppliers.

16. The system of claim 13, wherein the product data is read from a bill-of-material (BOM) and the one or more supplier data is read from a database table maintaining the one or more supplier data.

17. The system of claim 13, wherein merging the one or more generated suppliers' timeline topology with time inter-dependency relationship between each node further comprises removing redundant nodes.

18. The system of claim 13, wherein selecting the optimal route further comprises:
determining a total capital cost of the product for each of the determined one or more routes;
normalizing the determined total capital cost of the product for each of the determined one or more routes;
determining manufacturing lime of the product for each of the determined one or more routes;
normalizing the determined manufacturing time of the product for each of the determined one or more routes; and
selecting the route having minimum normalized total capital cost and minimum normalized manufacturing time as the optimal route.

19. The system of claim 18, wherein the normalization is done using linear programming.

20. The system of claim 13, wherein the processor is further configured to execute the executable instructions to:
receive one or more runtime constraints from at least one of the manufacturer and the one or more suppliers:
based upon the received one or more runtime constraints, update the optimized planning schedule; and
based upon the updated optimized planning schedule, re-assign the one or more tasks to the one or more suppliers.
